(19) United States
(12) Patent Application Publication
(10) Pub. No.: US 2007/0278922 A1
(43) Pub. Date: Dec. 6, 2007

(54) Film type filter and plasma display panel comprising the same

(76) Inventor: Ji-Suk Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/641,272

(22) Filed: Dec. 19, 2006

(30) Foreign Application Priority Data
Dec. 31, 2005 (KR) 10-2005-0136232

(51) Int. Cl. H01J 61/40; H01J 5/16; H01K 1/26; H01K 1/30

(52) U.S. Cl. 313/112

(57) ABSTRACT

Provided is a film type filter attached to the front surface of a plasma display panel (PDP) and formed to a thickness of about 100 μm to about 1500 μm in order to reduce the rate of process error.

### CROSS-REFERENCE TO RELATED PATENT APPLICATION

This application claims the priority of Korean Patent Application No. 10-2005-0136232, filed on Dec. 31, 2005 in the Korean Intellectual Property Office, the disclosure of which is incorporated herein in its entirety by reference.

### BACKGROUND OF THE INVENTION

1. Field of the Invention

The present embodiments relate to a film type filter, and a plasma display device having the same.

2. Description of the Related Art

A plasma display apparatus is a flat display device that uses a plasma display panel (PDP) and a plasma discharge to display an image. The plasma display apparatus is considered to be a next generation display device due to its high display performances such as high brightness, high contrast, clear image, large viewing angle, and a large thin screen.

However, in a conventional plasma display apparatus, there is a problem of double image reflection due to different refraction indexes of a front substrate and a reinforcing glass filter of the plasma display panel. Also, the reinforcing glass filter is heavy, since it must have a predetermined thickness (approximately 3 mm) to resist external impact, and is also expensive. Also, the conventional reinforcing glass filter has a very complicated structure composed of films having various functions. Thus, the films are complicated and expensive, thereby increasing the manufacturing cost of the plasma display apparatus.

In order to solve these problems, researches have recently been investigating a film type filter to be attached to a front surface of a PDP. However, since the film type filter is fabricated with a thin layer of a film, the film could be bent during a manufacturing process or is not adhered closely to the PDP.

### SUMMARY OF THE INVENTION

The present embodiments provide a film type filter that can be manufactured while reducing the rate of error during a manufacturing process, and a plasma display apparatus having the same.

According to an aspect of the present embodiments, there is provided a film type filter attached to a front surface of a plasma display panel and formed to a thickness of from about 100 μm to about 1500 μm.

The film type filter may include a base film, an antiglare layer, an electromagnetic wave shielding layer, an anti-reflective layer, a near-infrared ray shielding layer, and a color adjusting layer may be formed on a surface of the base film. Also, the film type filter may further comprise a shock-resistive base film that is formed on a surface of the base film and buffers an external impact.

The film type filter may include a structure in which a plurality of base films are stacked, and the number of the stacked base films may be about two to about four.

According to another aspect of the present embodiments, there is provided a plasma display apparatus having the above film type filter.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a partial cut-away perspective view of a film type filter for a plasma display apparatus according to an embodiment;

FIG. 2 is a cross-sectional view taken along the line II-II of FIG. 1;

FIG. 3 is a cross-sectional view of a modified version of the film type filter of FIG. 2;

FIG. 4 is a graph illustrating the result of an experiment in which the rate of error were measured while changing the thickness of a film type filter;

FIG. 5 is a cross-sectional view of a film type filter according to another embodiment;

FIG. 6 is a cross-sectional view of a film type filter according to another embodiment;

FIG. 7 is a cross-sectional view of a film type filter according to another embodiment;

FIG. 8 is a cross-sectional view of a film type filter according to another embodiment;

FIG. 9 is an exploded a plasma display panel (PDP) having a film type filter, such as shown in FIG. 1, according to an embodiment; and

FIG. 10 is a cross-sectional view taken along the line X-X of FIG. 9.

### DETAILED DESCRIPTION OF THE INVENTION

Hereinafter, a plasma display panel according to an embodiment will be described in detail with reference to the accompanying drawings.

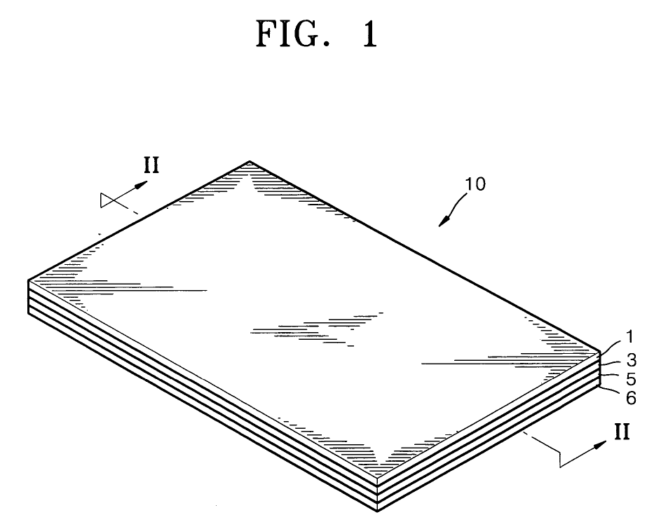

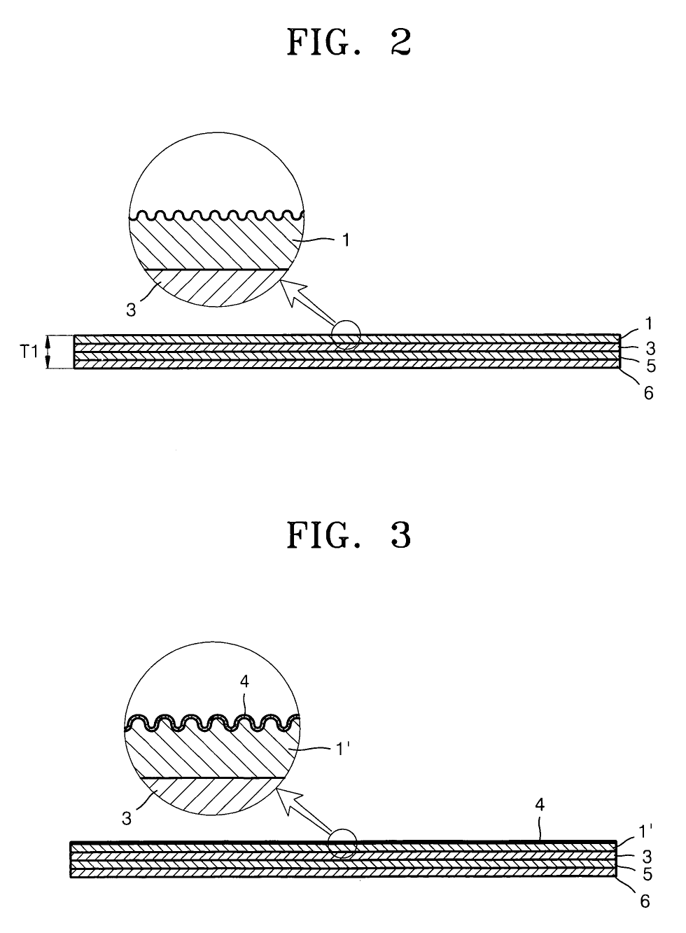

FIG. 1 is a perspective view of a film type filter 10 according to an embodiment. FIG. 2 is a cross-sectional view taken along the line II-II of FIG. 1.

Referring to FIGS. 1 and 2, the film type filter 10 includes a base film 3, an antiglare layer 1, an electromagnetic wave shielding layer 5, and an adhesive layer 6.

The base film 3 can be formed of polyethersulphone (PES), polyacrylate (PAR), polyetherimide (PEI), polyethyelene napthalate (PEN), polyethylene terephthalate (PET), polyphenylene sulfide (PPS), polyallylate, polyimide, polycarbonate (PC), triacetyl cellulose (TAC), or cellulose acetate propionate (CAP), and preferably, PC, PET, TAC, or PEN.

The base film 3 may be colored to improve bright room contrast or color temperature. Also, the transmissivity of visible light through the whole film type filter 10 may be controlled by adjusting conditions for coloring the base film 3.

The antiglare layer 1 is located on one surface of the base film 3. The antiglare layer 1 disperses external light incident on a surface thereof, and prevents the surroundings of the film type filter 10 from being reflected on the surface of the film type filter 10. If the antiglare layer 1 is applied to a conventional reinforcing glass filter, there is a disadvantage of reducing image definition due to a gap between a front substrate of a plasma display panel and the reinforcing glass filter. Therefore, the antiglare layer 1 cannot be applied to the conventional reinforcing glass filter. However, in the present embodiments, since the film type filter 10 can be attached directly onto a plasma display panel, image definition is not degraded. Therefore, the antiglare layer 1 can be applied to the film type filter 10 according to an embodiment.

The antiglare layer 1 can be formed according to, for example, a dipping coating method, an air-knife method, a curtain coating method, or a roller coating method.

The antiglare layer 1 may contain a hard coating material. Since plasma display apparatuses to which the film type filter 10 is to be applied are subject to various types of external forces in use, there is a high risk of scratching the plasma display apparatuses. Accordingly, a hard coating material is included into the antiglare layer 1 so as to prevent the display apparatuses from being scratched. Alternatively, an additional hard coating material layer 4 may further be formed on an antiglare layer 1′ as illustrated in FIG. 3.

The hard coating material may include a polymer as a binder, such as an acryl group polymer, a urethane group polymer, an epoxy group polymer, a siloxane group polymer, or an ultraviolet ray hardening resin such as an oligomer. A silica group filler can further be included in the hard coating material to increase hardness.

The electromagnetic wave shielding layer 5 is located on the other surface of the base film 3. The electromagnetic wave shielding layer 5 shields electromagnetic waves, which are harmful to the human body, which are generated from the plasma display apparatus. The electromagnetic wave shielding layer 5 is formed by stacking at least one layer of a metal layer or a metal oxide layer, and preferably, has a multilayer structure in which about 5 to about 11 layers are stacked. Particularly, when a metal oxide layer and a metal layer are stacked together, the metal oxide layer can prevent oxidation or degradation of the metal layer. Also, when the electromagnetic wave shielding layer 5 is formed as a multiple layer by stacking a plurality of layers, it is possible to not only correct the surface resistance of the electromagnetic wave shielding layer 5 but also control the transmittance of visible light.

The metal layer may be formed of, for example, palladium, copper, platinum, rhodium, aluminum, iron, cobalt, nickel, zinc, ruthenium, tungsten, tin, iridium, lead, silver, or a composite or alloy of these metals.

The metal oxide layer may be formed of, for example, tin oxide, indium oxide, antimony oxide, zinc oxide, zirconium oxide, titan oxide, magnesium oxide, silicon oxide, aluminum oxide, alcoxide, indium tin oxide (ITO), or antimony tin oxide ATO.

The electromagnetic wave shielding layer 5 may be formed, for example, by sputtering, vacuum evaporation, ion plating, chemical vapor deposition (CVD), or physical vapor deposition (PVD).

The metal layer of the metal oxide layer shields not only electromagnetic waves but also near-infrared rays, thereby reducing the malfunctions of peripheral electronic devices due to the near-infrared rays.

The shape of the electromagnetic wave shielding layer 5 is not limited to the above description. For example, the electromagnetic wave shielding layer 5 may be made in the form of a mesh by using conductive metal.

The adhesive layer 6 is formed on the electromagnetic wave shielding layer 5. The adhesive layer 6 is used for attaching the film type filter 10 to the plasma display panel. The adhesive layer 6 is preferably be fabricated such that the difference between the diffraction indexes of the adhesive layer 6 and the display panel does not exceed a reference value in order to reduce the double image reflection phenomenon.

The adhesive layer 6 may include a thermoplastic resin or a UV setting resin, for example, an acryl late group resin or a pressure sensitive adhesive (PSA). The adhesive layer 6 may be formed according to a dipping coating method or an air-knife method.

The adhesive layer 6 may further include a compound that absorbs near-infrared rays. The compound may be a resin that includes copper atoms, a resin that includes a copper compound or a phosphate compound, a resin that includes a copper compound or a thio-urea derivative, a resin that includes a tungsten compound, or a cyanine group compound.

Also, the adhesive layer 6 may further include a color material, such as a pigment or a dye, in order to shield neon light for color correction. The color material selectively absorbs light having a wavelength of from about 400 to about 700 nm, which corresponds to visible light. Particularly, when a discharge occurs in the plasma display panel, unnecessary visible light having a wavelength of approximately 585 nm is generated by neon gas which is an example of a discharge gas. To absorb the unnecessary visible light, compounds, such as a cyanine group, a squarylium group, an azomethine group, a xanthene group, an oxonol group, or an azo group, may be used. The adhesive layer 6 includes fine particles of the color material in a dispersed state.

The film type filter 10 may be formed to various thicknesses T1. That is, the thickness T1 of the film type filter 10 may be freely adjusted by controlling the thicknesses of the base film 3, the antiglare layer 1, the electromagnetic wave shielding layer 5, and the adhesive layer 6.

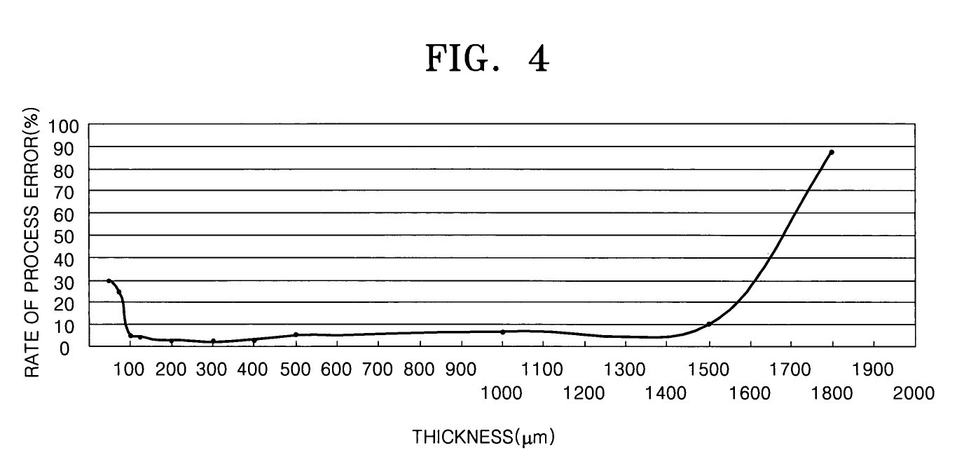

FIG. 4 is a graph illustrating the result of an experiment in that the rate of process error was measured while changing the thickness T1 of a film type filter. Referring to FIG. 4, when the thickness T1 is 50 μm, 75 μm, 100 μm, 125 μm, 200 μm, 300 μm, 400 μm, 500 μm, 1000 μm, 1500 μm, or 1800 μm, the rate of process error is 30%, 25%, 5%, 4%, 3%, 2%, 3%, 5%, 7%, 10%, or 87%, respectively. In particular, when the thickness T1 is less than 100 μm, the rate of process error is significantly increased. That is, the less the thickness T1 of the film type filter, the greater the rate of process error due to the bending of the film type filter.

Accordingly, the thickness T1 of the film type filter is preferably from about 100 μm to about 1500 μm in order to reduce the rate of process error.

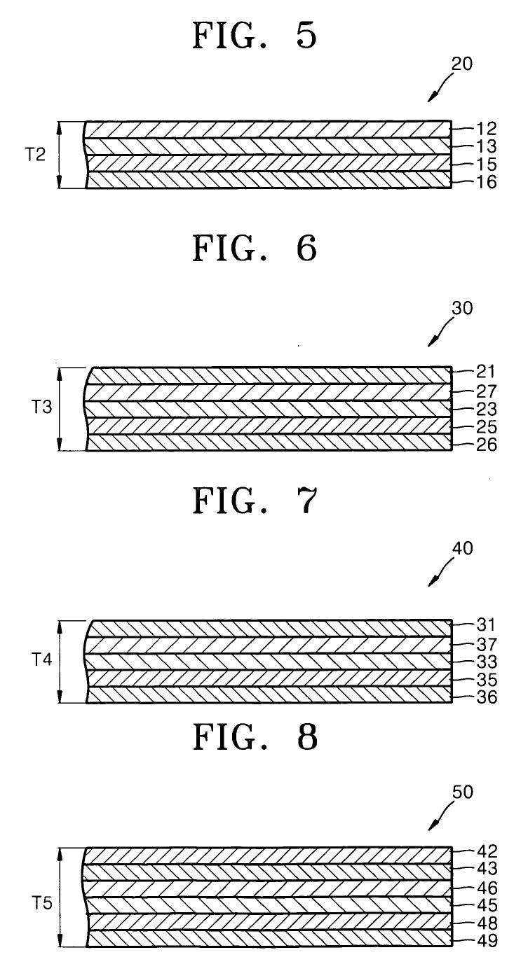

FIG. 5 is a cross-sectional view of a film type filter 20 according to another embodiment. The film type filter 20 includes a base film 13, an electromagnetic wave shielding layer 15, an anti-reflective layer 12, and an adhesive layer 16.

The base film 13 is formed to a flat sheet shape, and various materials may be used to make the base film 13.

The electromagnetic wave shielding layer 15 is formed on a surface of the base film 13. The electromagnetic wave shielding layer 15 may be formed by stacking at least one layer of a metal layer or a metal oxide layer, or be formed as a pattern of conductive metal in the form of a mesh.

The adhesive layer 16 is formed on the electromagnetic wave shielding layer 15 to facilitate adhesion of the film type filter 20 to a PDP. The adhesive layer 16 may further contain a compound that absorbs near-infrared rays. Also, the adhesive layer 16 may further contain a pigment or a dye in order to shield neon light for color correction.

The anti-reflective layer 12 is formed on the other surface of the base film 13. The anti-reflective layer 12 prevents visible light incident thereon from being reflected onto the outside. The anti-reflective layer 12 is obtained by stacking material layers with different refractive indexes.

Similar to the film type filter 10 of the FIG. 1, the thickness T2 of the film type filter 20 is preferably from about 100 μm to about 1500 μm in order to reduce the rate of process error.

FIG. 6 is a cross-sectional view of a film type filter 30 according to another embodiment. The film type filter 30 includes a base film 23, an electromagnetic wave shielding layer 25, a near-infrared ray shielding layer 27, an antiglare layer 21, and an adhesive layer 26.

The base film 13 is formed to a flat sheet shape, and various materials may be used to make the base film 13.

The electromagnetic wave shielding layer 25 is formed on a surface of the base film 13. The electromagnetic wave shielding layer 25 may be formed by stacking at least one layer of a metal layer or a metal oxide layer, or be formed as a pattern of conductive metal in the form of a mesh.

The adhesive layer 26 is formed on the electromagnetic wave shielding layer 25 to facilitate adhesion of the film type filter 30 to a PDP. The adhesive layer 16 may further contain a pigment or a dye in order to shield neon light for color correction.

The near-infrared ray shielding layer 27 is formed on the other surface of the base film 23 to shield near-infrared rays generated by the PDP.

The antiglare layer 21 is formed on the near-infrared ray shielding layer 27 to reduce the glare phenomenon. Alternatively, an anti-reflective layer may be formed instead of the antiglare layer 21.

Similarly to the film type filter 10 of the FIG. 1, the thickness T3 of the film type filter 30 is preferably from about 100 μm to about 1500 μm in order to reduce the rate of process error.

FIG. 7 is a cross-sectional view of a film type filter 40 according to another embodiment. The film type filter 40 includes a base film 33, an electromagnetic wave shielding layer 35, a color adjusting layer 37, an antiglare layer 31, and an adhesive layer 36.

The base film 33 is formed to a flat sheet shape, and various materials may be used to make the base film 33.

The electromagnetic wave shielding layer 35 is formed on a surface of the base film 33. The electromagnetic wave shielding layer 35 may be formed by stacking at least one layer of a metal layer or a metal oxide layer, or may be formed as a pattern of conductive metal in the form of a mesh.

The adhesive layer 36 is formed on the electromagnetic wave shielding layer 35 to facilitate adhesion of the film type filter 40 to a PDP. The adhesive layer 36 may further contain a pigment or a dye in order to shield neon light for color correction.

The color adjusting layer 38 is formed on the other surface of the base film 33. The color adjusting layer 38 is used to adjust the degree of purity of visible light emitted from the PDP, or color temperature.

The color adjusting layer 38 selectively absorbs light having a wavelength of from about 400 to about 700 nm. Particularly, when a discharge occurs in the plasma display panel, unnecessary visible light having a wavelength of approximately 585 nm is generated by neon gas which is a discharge gas. To absorb the unnecessary visible light, compounds, such as a cyanine group, the color adjusting layer 38 may include an azomethine group, a xanthene group, an oxonol group, or an azo group.

The antiglare layer 31 is formed on the color adjusting layer 38 to reduce the glare phenomenon. Alternatively, an anti-reflective layer may be formed instead of the antiglare layer 21.

Similarly to the film type filter 10 of the FIG. 1, the thickness T4 of the film type filter 40 is preferably from about 100 μm to about 1500 μm in order to reduce the rate of process error.

FIG. 8 is a cross-sectional view of a film type filter 50 according to another embodiment. The film type filter 50 includes a first base film 43, a second base film 48, an electromagnetic wave shielding layer 45, an anti-reflective layer 42, an adhesive layer 46, and a shock-resistive base film 49.

The first base film 43 is formed to a flat sheet shape, and various materials may be used to make the base film 43.

The anti-reflective layer 42 is formed on a surface of the first base film 43 to reduce reflection of light emitted from the outside, thereby improving bright room contrast. Alternatively, an antiglare layer may be formed instead of the anti-reflective layer 42.

The adhesive layer 46 is formed on the other surface of the first base film 43, and the electromagnetic wave shielding layer 45 is formed on the adhesive layer 46. The adhesive layer 46 may be formed by stacking at least one layer of a metal layer or a metal oxide layer, or be formed as a pattern of conductive metal in the form of a mesh. Alternatively, the electromagnetic wave shielding layer 45 may be formed directly on the first base film 43 without the adhesive layer 46.

The second base film 48 is formed on the electromagnetic wave shielding layer 45. If the electromagnetic wave shielding layer 45 is formed in the form of a mesh pattern, the adhesive layer 46 is present on a part of the electromagnetic wave shielding layer 45, which does not have the mesh pattern. Thus, the first and second base films 43 and 48 may be directly adhered to each other. However, if the electromagnetic wave shielding layer 45 is formed of a plurality of metal layers, an additional adhesive layer is preferably formed to glue the electromagnetic wave shielding layer 45 and the second base film 48 together.

The shock-resistive base film 49 is formed on the second base film 48. The film type filter 50 is attached to a front surface of the PDP, and thus, the shock-resistive base film 49 buffers external impacts to protect the PDP. The shock-resistive base film 49 may be formed of an acryl-based material or a silicon-based material. Alternatively, instead of the shock-resistive base film 49, an adhesive layer having both buffering and adhesive characteristics may be formed on the second base film 48.

The film type filter 50 has a structure in which the three base films 43, 48, and 49 are stacked. However, the film type filter 50 is not limited to the above structure. For example, the film type filter 50 may be fabricated by stacking a plurality of base films, and preferably, two to four base films. The number of base films is determined in consideration of the function and costs of the film type filter 50. In one embodiment, a near-infrared ray shielding layer, an electromagnetic wave shielding layer, a color adjusting layer, and an antiglare layer are formed on each of the base films. It is possible to fabricate a film type filter by gluing the base films together via an adhesive.

Similar to the film type filter 10 of the FIG. 1, the thickness T5 of the film type filter 50 is preferably from about 100 μm to about 1500 μm in order to reduce the rate of process error.

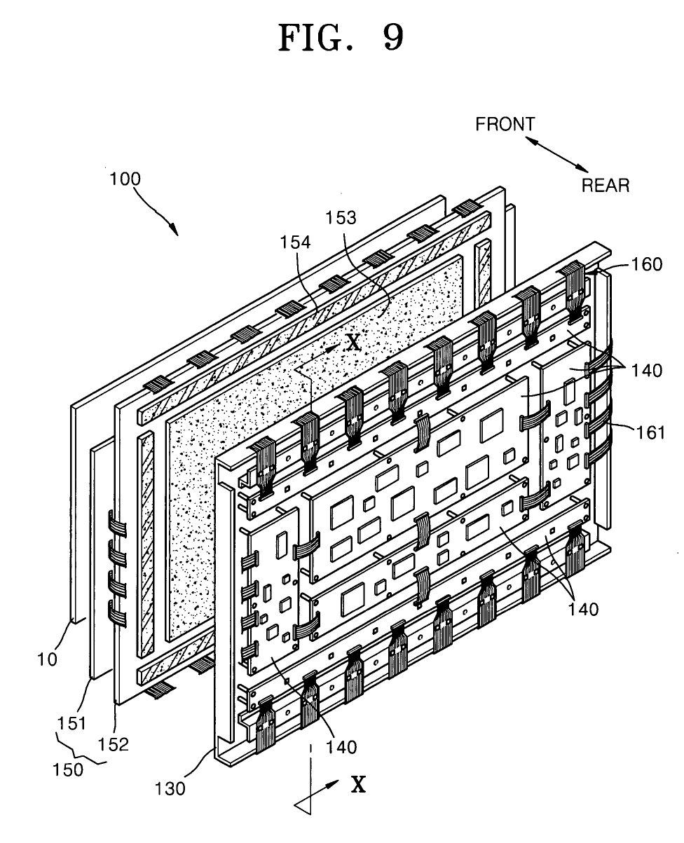

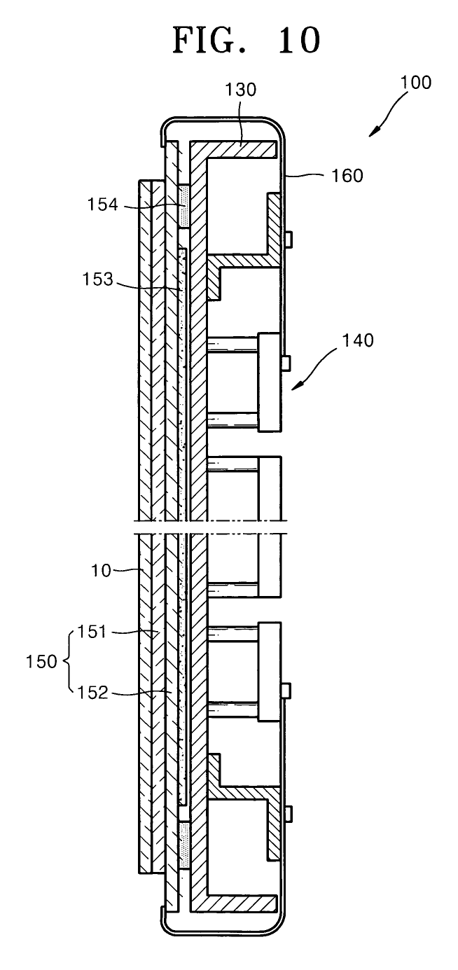

FIGS. 9 and 10 illustrate a plasma display apparatus 100 having the film type filter 10 of FIG. 1, according to an embodiment. FIG. 9 is an exploded perspective view of the plasma display apparatus 100, and FIG. 10 is a cross-sectional view taken along line II-II of FIG. 9. In describing the plasma display panel 100, like elements recited in the aforementioned embodiments will be described with like reference numerals.

The plasma display apparatus 100 includes a film type filter 10, a plasma display panel 150, a chassis 130, a thermal conductive member 153, a plurality of double-faced adhesive tapes 154, and a circuit unit 140.

The plasma display panel 150 displays an image using a gas discharge, and includes a front panel 151 and a rear panel 152 coupled to each other.

The film type filter 10 is attached onto the front surface of the plasma display panel 150 via the adhesive layer 6 illustrated in FIG. 1. However, the plasma display apparatus 100 according to an embodiment is not limited to a structure having the film type filter 10. For example, all of the film type filters 20 through 50 are applicable to the plasma display apparatus 100.

The film type filter 10 shields electromagnetic waves generated from the plasma display panel 150, and reduces the glare phenomenon. Also, the film type filter 10 can shield infrared rays or neon light. Furthermore, the double image reflection problem can be fundamentally solved since the film type filter 10 is attached directly onto the front surface of the plasma display panel 150.

The film type filter 10 is lighter and less expensive to manufacture than a conventional reinforcing glass filter.

Also, since the thickness T1 of the film type filter 10 is optimised, use of the film type filter 10 reduces the rate of process error during a process.

The chassis 130 is located on the rear of the plasma display panel 150 to structurally support the plasma display panel 150. The chassis 130 may be formed of a metal having high strength, such as aluminum or iron, or a plastic.

The thermal conductive member 153 is located between the plasma display panel 150 and the chassis 130. Also, the dual-faced adhesive tapes 154 are located along edges of the thermal conductive member 153 in order to fix the plasma display panel 150 and the chassis 130 together.

The circuit unit 140 is located at the rear of the chassis 130, and includes a circuit for driving the plasma display panel 150. The circuit unit 140 transmits electrical signals to the plasma display panel 150 via signal transmitting units. The signal transmitting units may be flexible printed cables (FPCs), tape carrier packages (TCP), or chip-on-films (COF). According to one embodiment, FPCs 161 are located on the left and right sides of the chassis 130, and TCPs 160 are located on the upper and lower sides of the chassis 130.

Accordingly, it is possible to reduce the rate of process error in a film type filter and a plasma display apparatus having the same according to the present embodiments, thereby improving working efficiency and reducing manufacturing costs.

While these embodiments have been particularly shown and described with reference to exemplary embodiments thereof, it will be understood by those skilled in the art that various changes in form and details may be made therein without departing from the spirit and scope of the present embodiments as defined by the appended claims.

What is claimed is:

1. A film type filter comprising a base film; and
an antiglare layer formed on a surface of the base film,
wherein the film type filter is attached to a front surface of a plasma display panel and formed to a thickness from about 100 μm to about 1500 μm.

2. The film type filter of claim 1, wherein the antiglare layer comprises a hard coating material to protect the film type filter from being scratched due to an external impact.

3. The film type filter of claim 1, further comprising an electromagnetic wave shielding layer formed on a surface of the base film.

4. The film type filter of claim 1, further comprising an anti-reflective layer formed on a surface of the base film.

5. The film type filter of claim 1, further comprising an adhesive layer configured to adhere the film type filter and the plasma display panel together.

6. The film type filter of claim 1, further comprising a near-infrared ray shielding layer formed on a surface of the base film.

7. The film type filter of claim 1, further comprising a color adjusting layer formed on a surface of the base film.

8. The film type filter of claim 7, wherein the color adjusting layer selectively absorbs light having a wavelength of about 400 μm to about 700 μm.

9. The film type filter of claim 1, further comprising:
an electromagnetic wave shielding layer formed on a surface of the base film; and
an antiglare layer or an anti-reflective layer formed on the other surface of the base film.

10. The film type filter of claim 1, further comprising a shock-resistive base film formed on a surface of the base film.

11. The film type filter of claim 1, wherein a plurality of base films are stacked.

12. The film type filter of claim 11, wherein the number of the stacked base films is two to four.

13. A plasma display apparatus having a film type filter of claim 1.

14. A plasma display apparatus having a film type filter of claim 2.

15. A plasma display apparatus having a film type filter of claim 3.

16. A plasma display apparatus having a film type filter of claim 4.

17. A plasma display apparatus having a film type filter of claim 5.

18. A plasma display apparatus having a film type filter of claim 6.

19. A plasma display apparatus having a film type filter of claim 7.

20. A plasma display apparatus having a film type filter of claim 8.

21. A plasma display apparatus having a film type filter of claim 9.

22. A plasma display apparatus having a film type filter of claim 10.

23. A plasma display apparatus having a film type filter of claim 11.

24. A plasma display apparatus having a film type filter of claim 12.
